(19) United States
(12) Patent Application Publication
(10) Pub. No.: US 2016/0089659 A1
(43) Pub. Date: Mar. 31, 2016

(54) PHOTOCATALYTIC FILTER FOR DEGRADING MIXED GAS AND MANUFACTURING METHOD THEREOF

(71) Applicant: Seoul Viosys Co., Ltd., Ansan-si (KR)

(72) Inventors: Jaeseon Yi, Seoul (KR); Daewoong Suh, Seoul (KR); Geundo Cho, Ansan-si (KR); Doug Youn Lee, Ansan-si (KR); Hye Kyung Ku, Ansan-si (KR); Kyung Sik Yoon, Ansan-si (KR)

(21) Appl. No.: 14/871,907

(22) Filed: Sep. 30, 2015

Related U.S. Application Data
(60) Provisional application No. 62/057,794, filed on Sep. 30, 2014.

(30) Foreign Application Priority Data
Feb. 9, 2015 (KR) 10-2015-0019753

(51) Int. Cl. B01J 23/888; B01J 35/04; B01J 37/08; B01J 35/00; B01J 37/02

(52) U.S. Cl. CPC B01J 23/888; B01J 35/004; B01J 37/0215; B01J 37/0236; B01J 37/08; B01J 35/04

(57) ABSTRACT

The present disclosure relates to a photocatalytic filter, the surface of which has enhanced adsorption performance so that mixed gases including a gas that reacts later in a competitive reaction can be degraded from the initial stage of a photocatalytic reaction, and to a manufacturing method thereof. The method includes: dispersing carbon dioxide (TiO₂) nanopowder as a photocatalyst and one or more metal compounds in water to prepare a photocatalytic dispersion; coating a support with the photocatalytic dispersion; drying the coated support; and sintering the dried support. The photocatalytic filter includes a support, and a photocatalyst and one or more metal compounds, which are coated on the support. The metal compounds include nanopowers of an iron (Fe) compound.

### CROSS-REFERENCE TO RELATED APPLICATIONS

This patent document claims priority to Provisional Application No. 62/057,794 filed on Sep. 30, 2014, and Korean Patent Application No. 10-2015-0019753 filed on Feb. 9, 2015. The entire disclosure of the above applications are incorporated by reference in their entirety as part of this document.

### TECHNICAL FIELD

The present disclosure relates to a photocatalytic filter and a manufacturing method thereof.

### BACKGROUND

As used herein, the term “photocatalytic reaction” refers to reactions that use photocatalytic materials such as titanium dioxide (TiO₂) or the like. Known photocatalytic reactions include photocatalytic degradation of water, electrodeposition of silver and platinum, degradation of organic materials, etc. Also, there have been attempts to apply such photocatalytic reactions to new organic synthetic reactions, ultrapure water production and the like.

Toxic gases or offensive odor substances, such as ammonia, acetic acid and acetaldehyde, which are present in air, are degraded by the above-described photocatalytic reactions, and air purification devices based on such photocatalytic reactions can be used semi-permanently if they have a light source (e.g., a UV light source) and a filter coated with a photocatalytic material. When photocatalytic efficiency of the photocatalytic filter has reduced, the filter can be regenerated to restore its photocatalytic efficiency, and then it can be reused. Thus, it can be said that the photocatalytic filter is semi-permanent.

Particularly, when a UV LED lamp is used as a UV light source, it is advantageous over a conventional mercury lamp or the like in that it is environmentally friendly because it does not require toxic gas, is highly efficient in terms of energy consumption, and allows various designs by virtue of its small size.

### SUMMARY

Various embodiments provide a photocatalytic filter, which shows a high removal rate of each gas even when mixed gases pass therethrough, and a method for manufacturing the photocatalytic filter, the photocatalyst of which has high adhesion to a base or a substrate.

In an aspect, a method of manufacturing a photocatalytic filter is provided to include: providing a photocatalytic dispersion by dispersing titanium dioxide (TiO₂) nanopowders and metal compounds in water, the metal compounds include nanopowders including an iron (Fe) compound; coating a support with the photocatalytic dispersion; drying the coated support; and sintering the dried support.

In another aspect, a photocatalytic filter is provided to include: a support; and a photocatalytic material and metal compound coated on the support, wherein the metal compounds include nanopowders including an iron (Fe) compound.

In some implementations, the metal compound may include a tungsten (W) compound including atom H.

In some implementations, the tungsten (W) compound may include H₂WO₄.

In some implementations, the tungsten (W) compound may be used at a molar ratio between 0.0032 and 0.0064 moles per mole of the TiO2.

In some implementations, the metal compounds include a tungsten (W) compound including H₂WO₄, WO₃, WCl₆, or CaWO₄.

In some implementations, the iron compound may include FeCl₂, FeCl₃, Fe₂O₃, or Fe(NO₃)₃. In some implementations, the iron (Fe) compound includes a Fe³⁺ compound.

In some implementations, the iron (Fe) compound has a molar ratio between 0.005 and 0.05 moles per mole of the TiO₂.

In some implementations, the iron (Fe) compound may have a molar ratio between 0.00125 and 0.0125 moles per mole of titanium dioxide.

In some implementations, the tungsten (W) compound has a molar ratio between 0.0032 and 0.0064 moles per mole of titanium dioxide.

In some implementations, the photocatalytic support may include a porous ceramic material.

In some implementations, the coating of the photocatalytic support may include dipping the photocatalytic support in the dispersion.

In some implementations, the sintering of the dried support may be performed at a temperature between 350° C. and 500° C. for 0.5-3 hours.

In some implementations, a photocatalytic filer is provided to include: a photocatalytic support; and a photocatalytic material and metal compounds coated on the photocatalytic support, wherein the metal compounds include a tungsten (W) compound and an iron (Fe) compound.

In some implementations, the tungsten compound may include H₂WO₄, and the iron compound may include Fe₂O₃.

In some implementations, the tungsten (W) compound may have a molar ratio between 0.016 and 0.048 moles based on mole of TiO₂, and the iron compound may have a molar ratio between 0.005 and 0.025 moles based on mole of TiO₂.

In some implementations, the iron compound may include nanosized powder.

In some implementations, the tungsten (W) compound may have a molar ratio between 0.016 and 0.048 moles based on mole of TiO₂, and the iron compound may have a molar ratio between 0.00125 and 0.00625 moles based on mole of TiO₂.

In some implementations, the photocatalytic support may include porous ceramic.

In some implementations, the photocatalytic material and the metal compounds may be anchored onto the photocatalytic support by sintering.

### BRIEF DESCRIPTION OF THE DRAWINGS

FIG. 1 shows removal rates of toxic gases as a function of time when using a conventional photocatalytic filter and a photocatalytic filter according to one implementation of the disclosed technology.

FIG. 2 shows removal rates of toxic gases as a function of time when using a conventional photocatalytic filter and a photocatalytic filters according to one implementation of the disclosed technology.

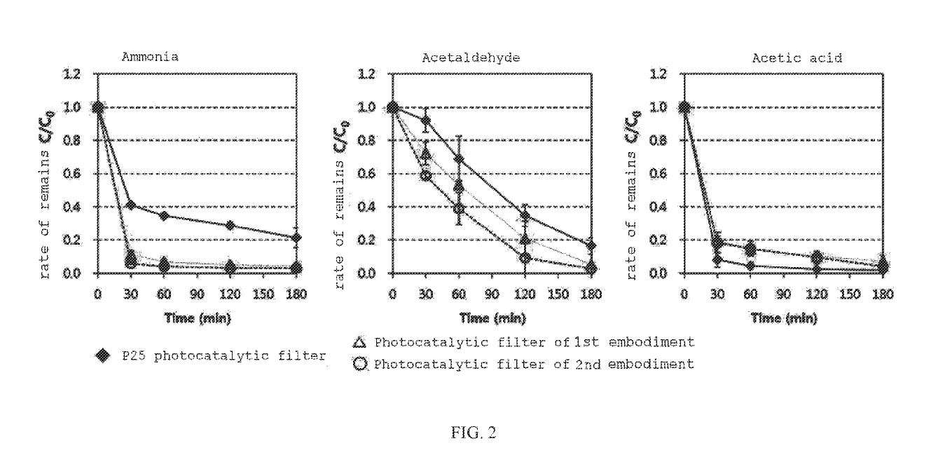

### DETAILED DESCRIPTION

The photocatalytic filter is configured such that toxic gases adsorbed on the surface of the filter during the passage of air through the filter are degraded by reactive oxygen species such as Off, generated by the photocatalytic reaction. This is different from conventional filters such as the pre-filter or HEPA filter, which physically collect large dust particles when air passes therethrough. For the photocatalytic filter, degrading efficiency of toxic gases is mainly affected by the efficiency of contact between target toxic gases and activated site of the photocatalytic filter's surface.

The photocatalytic efficiency of the photocatalytic filter is directly dependent on the air cleaning ability of the photocatalytic filter. Toxic gas in a space that uses an air cleaner having high photocatalytic efficiency is degraded faster than toxic gas in a space that uses an air cleaner having the same size and structure, but having a relatively low photocatalytic efficiency.

Meanwhile, it is known that, when air contains a plurality of different toxic gases, the toxic gases are degraded in the order in which they are adsorbed onto the surface of the photocatalytic filter. Thus, among toxic gases, a gas that is absorbed into the photocatalytic surface at higher rate is degraded faster, and a gas that is adsorbed onto the photocatalytic surface at lower rate is adsorbed and degraded on the photocatalytic surface after the gas adsorbed at higher rate was somewhat degraded.

The deodorization performance test method provided by the Korea Air Cleaning Association includes evaluating the removal rate of a mixture of three gases: acetaldehyde, ammonia, and acetic acid. The results of experiments conducted according to this test method indicated that a commercially available TiO₂ photocatalyst shows a low removal rate of acetaldehyde among the gases. This is because acetaldehyde reacts later than other gases in a competitive reaction. In other words, the conventional photocatalytic filter is configured such that it degrades a toxic gas that reacts first in a competitive reaction, and then degrades a toxic gas that reacts later.

This propensity of the conventional photocatalytic filter is not desirable from the point of view of air cleaners. In the case of air cleaners that use the photocatalytic reactions, the performance of degrading toxic gases is important, and furthermore, the performance of degrading all types of toxic gases should be excellent, and all types of toxic gases need to be degraded from the initial stage of a photocatalytic reaction.

Exemplary embodiments will be described below in more detail with reference to the accompanying drawings. The disclosure may, however, be embodied in different forms and should not be constructed as limited to the embodiments set forth herein.

The techniques disclosed in this patent document can be used to provide a photocatalytic filter with improved adsorption for acetaldehyde, ammonia and acetic acid gas mixture by introducing metal into titanium dioxide photocatalytic in the filter. An exemplary method for manufacturing the photocatalytic filter with improved adsorption for acetaldehyde, ammonia and acetic acid gas mixture includes providing a photocatalytic dispersion liquid by dispersing titanium dioxide nanopowders and one or more metal compounds in water, coating a photocatalytic support with the photocatalytic dispersion liquid, drying the coated photocatalytic support, and sintering the dried photocatalytic support.

A photocatalytic filter based on the disclosed technology includes a photocatalytic support and a photocatalytic material formed on the photocatalytic support. Under UV light exposure, the photocatalytic material is optically activated to cause a catalytic reaction with one or more targeted contaminants attached to the photocatalytic material coated on the photocatalytic support, e.g., via physical adsorption, therefore removing the contaminants from a gas medium. Targeted contaminants may be microorganisms or other biological material, or one or more chemical substances. A UV light source, such as UV LEDs, can be included to direct UV light to the photocatalytic material formed on the photocatalytic support. Such a photocatalytic filter can be used as an air filter or other filter applications. The photocatalytic material can include, for example, titanium dioxide nanopowders and one or more metal compounds.

A photocatalytic filter according to an embodiment of the present disclosure includes the tungsten (W) and iron (Fe) metal compounds added to a conventional photocatalytic TiO₂ material, and thus shows a high removal rate of mixed gases. In other words, according to the present disclosure, the acidity of the surface of the TiO₂ photocatalyst can be adjusted by adding the metal compounds to the TiO₂ photocatalyst, and thus the ability of the TiO₂ photocatalyst to adsorb gas compounds can be enhanced, thereby increasing the ability of the TiO₂ photocatalyst to remove toxic gas.

In addition, the photocatalytic filter according to the second embodiment of the present disclosure shows higher rates of removal of mixed gases, because a nano sized Fe compound is introduced in the process of introducing the metal materials (W and Fe) or their oxides into the conventional TiO₂ photocatalytic material.

Method for Manufacturing Photocatalytic Filter

A method for manufacturing a photocatalytic filter according to the present disclosure is as follows. The method may include the steps of: dispersing photocatalytic TiO₂ nanopowders, a tungsten (W) compound and an iron (Fe) compound in water to prepare a photocatalytic dispersion; coating a porous ceramic honeycomb support with the photocatalytic dispersion; drying the coated support; and sintering the dried support.

As the TiO₂ nanopowder, commercially available Evonik P25 powder may be used.

The W compound that is used in the present disclosure may be H₂WO₄, WO₃, WCl₆, CaWO₄ or the like, and the Fe compound that is used in the present disclosure may be FeCl₂, FeCl₃, Fe₂O₃, Fe(NO₃)₃ or the like. In an exemplary embodiment of the present disclosure, H₂WO₄ is used as the W compound, and Fe₂O₃ is used as the Fe compound.

The reason why H₂WO₄ (tungsten oxide hydrate) among W compounds is used is to introduce WO₃ into the photocatalytic nanopowder. In other words, H₂WO₄ is used as a precursor for introducing WO₃. In other words, in the case in which H₂WO₄ is introduced as a WO₃ precursor, the reactivity between WO₃ and TiO₂ can be increased by a dehydration reaction compared to the case in which WO₃ powder is directly added.

With respect to the Fe compound, Fe²⁺ has an electronic configuration of 1s² 2s² 2p² 3s² 3p⁶ 3d⁶, in which the number of electrons in the outermost shell is greater than half of the valence electrons by one. Also, Fe³⁺ has an electronic configuration of 1s² 2s² 2p² 3s² 3p⁶ 3d⁵, in which the number of electrons in the outermost shell is equal to the number of the valence electrons. Thus, Fe²⁺ has a strong tendency to donate one outermost electron to become relatively stable Fe³⁺ equal to half of the valence electrons. The electron donated from Fe²⁺ as described above reacts with H⁺ produced in the excitation reaction of TiO₂. Thus, when Fe²⁺ is used, the electron donated from Fe²⁺ reacts with H⁺ produced in the excitation reaction of TiO₂, and thus Fe²⁺ is converted into Fe³⁺ which then participates in a photocatalytic reaction. In other words, although Fe²⁺ and Fe³⁺ promote photocatalytic reactions, Fe³⁺ more efficiently promotes the photocatalytic reaction compared to Fe²⁺.

Compounds that are used to introduce Fe into the photocatalytic nanopowder include FeCl₃, Fe₂O₃, Fe(NO₃)₃ and the like. Among these compounds, FeCl₃ and Fe(NO₃)₃ cause a problem during mixing with H₂WO₄, or does not show an increase in photocatalytic activity. However, the results of an experiment indicate that Fe₂O₃ can exhibit a synergistic effect with H₂WO₄. Thus, Fe₂O₃ is preferably used as the Fe compound.

In the first embodiment of the present disclosure, based on the total moles of TiO₂, H₂WO₄ may be used in an amount of 0.0032 to 0.064 mole %, and Fe₂O₃ may be used in an amount 0.005 to 0.05 mole %. In some implementations, based on the total moles of TiO₂, H₂WO₄ is used in an amount of 0.016 to 0.048 mole %, and Fe₂O₃ is used in an amount of 0.005 to 0.025 mole %.

Meanwhile, it was found that, when nano sized powder was used as a material for introducing Fe into the photocatalyst, the activity of the photocatalyst was further increased. In other words, in the second embodiment, the use of nano sized Fe₂O₃ leads to a further increase in the activity of the photocatalyst. Herein, H₂WO₄ may be used at a molar ratio between 0.0032 and 0.064 moles per mole of TiO₂, and Fe₂O₃ may be used at a molar ratio between 0.00125 and 0.0125 moles per mole of TiO₂. Preferably, H₂WO₄ may be used at a molar ratio between 0.016 and 0.048 moles per mole of TiO₂, and Fe₂O₃ may be used at a molar ratio between 0.00125 and 0.00625 moles per mole of TiO₂.

As the support for the photocatalytic nanopowders, a metal material, activated carbon, a ceramic material or the like may be used. In an exemplary embodiment of the present disclosure, a porous ceramic honeycomb material is used as the support in order to increase the adhesion of the photocatalytic compound. When the porous ceramic honeycomb material is used as the support, the dispersion of the photocatalytic nanopowders penetrates the pores of the ceramic material in the coating step, and the photocatalytic nanoparticles are anchored to the pores after the drying step, thereby increasing the adhesion of the photocatalytic nanoparticles to the ceramic material. If a metal material is used as the support, it will not easy to attach the photocatalytic nanoparticles to the metal material, compared to attaching the photocatalytic nanoparticles to the ceramic material. In addition, although activated carbon has pores, it can be broken during the sintering step in some cases, and thus the use thereof as the support is undesirable. Thus, if a metal is used as the support, a photocatalytic dispersion prepared so as to be easily coated on the metal is required. Although it is known that a photocatalyst can be coated on any material, it is required to prepare a dispersion depending on the property of each support. In addition, a method of coating the photocatalyst directly on activated carbon having pores can also be contemplated, but in this case, the surface area of the pores can be reduced by coating with the photocatalyst, and thus the inherent function of the activated carbon can be lost. Thus, like the case of the metal, it is important coating conditions that satisfy the property of the support.

In the process of preparing the photocatalytic dispersion, Evonik P25 TiO₂ powder, the W compound and the Fe compound or nanopowder are dispersed using a silicone-based dispersing agent. The silicone-based dispersing agent is used in an amount of 0.1-10 wt % based on the total weight of P25 TiO₂ powder, the W compound and the Fe compound. Specifically, 0.1-10 wt % of the silicone-based dispersing agent is dissolved in water, and then P25 TiO₂ nanopowder, the W compound and the Fe compound are added to the solution and dispersed using a mill or a ball mill, thereby obtaining a TiO₂ dispersion having a solid content of 20-40 wt % based on the weight of the dispersion. Herein, one or more dispersing agents may be used.

In the coating step, a porous ceramic support is dip-coated with the above-prepared photocatalytic dispersion. During the dip coating, the support coated with the photocatalytic dispersion is allowed to stand for 1-5 minutes so that the photocatalytic dispersion can be sufficiently absorbed into the pores of the ceramic material.

In the drying step, the ceramic support coated with the photocatalyst is maintained in a dryer at 150˜200° C. for 3-5 minutes to remove water.

In the sintering step, the photocatalyst-coated ceramic honeycomb support resulting from the drying step is sintered in an electric furnace at 350˜500° C. for 0.5-3 hours. The results of an experiment indicated that, when the sintering temperature was lower than 300° C., the coated photocatalyst was detached from the support, and when the sintering temperature was between 400° C. and 500° C., the photocatalyst had high adhesion to the support. When the sintering temperature was higher than 500° C., the photocatalytic material was denatured, resulting in a decrease in photocatalytic reaction efficiency. From the experimental results, it can be seen that the adhesion of the photocatalyst is greatly influenced by the sintering temperature.

### Experiment on Removal of Mixed Gases

### 1. First Embodiment

Using a conventional photocatalytic filter coated with TiO₂ alone, and the photocatalytic filter according to the present disclosure, an experiment on the removal of mixed gases was performed in a 1 m³ chamber. The concentration of each gas in the mixed gases was 10 ppm. The conventional photocatalytic filter and the photocatalytic filter of the present disclosure were each loaded with 2.5 g of the photocatalyst to the support, and were irradiated with UV light using the same UV light source.

The molar ratios between components in the photocatalytic filter according to the present disclosure were as follows: TiO₂/H₂WO₄/Fe₂O₃=1.0/0.032/0.01; TiO₂/H₂WO₄/Fe₂O₃=1.0/0.032/0.015; and TiO₂/H₂WO₄/Fe₂O₃=1.0/0.032/0.02.

The conventional photocatalytic filter coated with TiO₂ alone, and the photocatalytic filter of the present disclosure were tested for their abilities to remove mixed gases. The results of the experiments are shown in Tables 1 and 2 below. As can be seen in the Tables, in the experiment performed using the conventional photocatalytic filter coated with TiO₂ alone, acetaldehyde was not removed for 30 minutes after the start of the experiment, and started to be removed after other gases were somewhat removed. However, in the deodorization experiment performed using the photocatalytic filter of the present disclosure, acetaldehyde was removed from the initial stage of the experiment, and the removal rate of ammonia by the photocatalytic filter of the present disclosure was also higher than that that shown by the conventional photocatalytic filter, suggesting that the photocatalytic filter of the present disclosure has an improved ability to remove all the gases.

TABLE 1
Removal rate at 30 minutes after start of reaction

| | | H₂WO₄/ | H₂WO₄/ | H₂WO₄/ |
|---|---|---|---|---|
| Removal | P25- | Fe₂O₃(0.010)/ | Fe₂O₃(0.015)/ | Fe₂O₃(0.020)/ |
| rate (%) | TiO₂ | TiO₂ | TiO₂ | TiO₂ |
| NH₃ | 40 | 52.6 | 70 | 63.2 |
| CH₃CHO | 0 | 20 | 20 | 20 |
| CH₃COOH | 50 | 30 | 50 | 35 |
| Total | 22.5 | 30.7 | 40 | 34.5 |

TABLE 2
Removal Rate at 120 minutes after start of reaction

| | | H₂WO₄/ | H₂WO₄/ | H₂WO₄/ |
|---|---|---|---|---|
| Removal | P25- | Fe₂O₃(0.010)/ | Fe₂O₃(0.015)/ | Fe₂O₃(0.020)/ |
| rate (%) | TiO₂ | TiO₂ | TiO₂ | TiO₂ |
| NH₃ | 55 | 73.7 | 85 | 75 |
| CH₃CHO | 25 | 60 | 60 | 50 |
| CH₃COOH | 85 | 70 | 75 | 60 |
| Total | 47.5 | 65.9 | 70 | 58.75 |

Total removal (%)={(CH₃CHO removal rate)*2+NH₃ removal rate+CH₃COOH removal rate}/4

* molar ratio

TiO₂/H₂WO₄/Fe₂O₃=100/10/2 weight ratio (TiO₂/H₂WO₄/Fe₂O₃=1.0/0.032/0.010 molar ratio)

TiO₂/H₂WO₄/Fe₂O₃=100/10/3 weight ratio (TiO₂/H₂WO₄/Fe₂O₃=1.0/0.032/0.015 molar ratio)

TiO₂/H₂WO₄/Fe₂O₃=100/10/4 weight ratio (TiO₂/H₂WO₄/Fe₂O₃=1.0/0.032/0.020 molar ratio).

In addition, from the above experimental results, it can be seen that a photocatalytic filter shows a high removal rate of each gas in mixed gases including three different gases (acetaldehyde, ammonia and acetic acid) and a high adhesion of the photocatalyst to the support, when a photocatalytic filter has a molar ratio of TiO₂/H₂WO4/Fe₂O₃=1.0/0.032/0.015. The temperature for sintering step may be between 350° C. and 500° C.

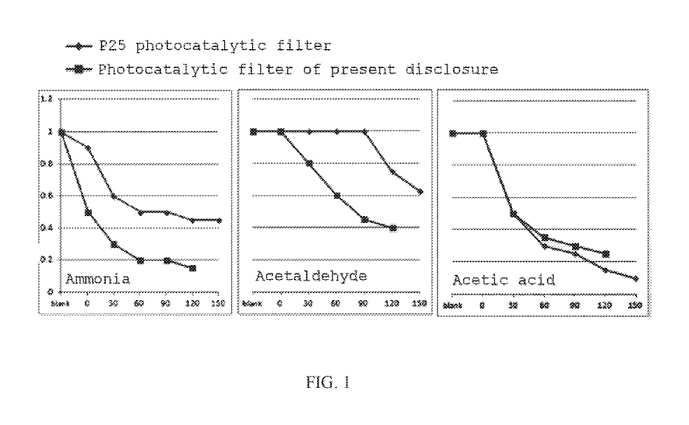

FIG. 1 and Table 3 below show a comparison of deodorization performance between a conventional P25 photocatalytic filter and the photocatalytic filter of the present disclosure, which has a molar ratio of TiO₂/H₂WO₄/Fe₂O₃=1.0/0.032/0.015.

TABLE 3

| | Removal rate (%) | | Removal rate (%) | |
|---|---|---|---|---|
| | after 30 minutes | | after 120 minutes | |
| | P25 | Photocatalytic | | Photocatalytic |
| | photo- | filter of the | P25 | filter of the |
| | catalytic | present | photocatalytic | present |
| Gases | filter | disclosure | filter | disclosure |
| NH₃ | 40% | 70% | 55% | 85% |
| CH₃CHO | 0% | 20% | 25% | 60% |
| CH₃COOH | 50% | 50% | 85% | 75% |
| Total | 22.5% | 40% | 47.5% | 70% |

As can be seen in Table 3 above and FIG. 1, the photocatalytic filter of the present disclosure, which has a molar ratio of TiO₂/H₂WO₄/Fe₂O₃=1.0/0.032/0.015, has significantly excellent deodorization performance compared to the conventional P25 photocatalytic filter.

### 2. Second Embodiment

Using each of a conventional P25 photocatalytic filter comprising TiO₂ alone and the photocatalytic filters according to the first embodiment and second embodiment of the present disclosure, an experiment on the removal of mixed gases was performed in a 4 m³ chamber. The concentration of each gas in the mixed gases was 10 ppm. The conventional photocatalytic filter and the photocatalytic filters of the present disclosure were all prepared by loading 2.5 g of the photocatalyst onto the support, and were irradiated with UV light using the same UV light source.

The molar ratio between components in each of the photocatalytic filters according to the first and second embodiments of the present disclosure were as follows: for the first embodiment, TiO₂/H₂WO₄/Fe₂O₃=1.0/0.032/0.015; and for the second embodiment, TiO₂/H₂WO₄/Fe₂O₃=1.0/0.032/0.005.

The conventional photocatalytic filter comprising TiO₂ alone, the photocatalytic filter prepared according to the first embodiment of the present disclosure, and the photocatalytic filter prepared according to the second embodiment of the present disclosure were tested for their abilities to remove mixed gases. The results of the experiments are shown in Table 4 below and FIG. 4. As can be seen therein, in the experiment on removal of mixed gases, performed using the conventional photocatalytic filter coated with TiO₂ alone, acetaldehyde was not substantially removed for 30 minutes after the start of the experiment, and started to be removed after other gases were somewhat removed. However, in the deodorization experiment performed using the photocatalytic filter prepared according to the first embodiment of the present disclosure, acetaldehyde was removed from the initial stage of the experiment, and the removal rate of ammonia by the photocatalytic filter of the first embodiment of the present disclosure was also higher than that that shown by the conventional photocatalytic filter, suggesting that the photocatalytic filter according to the first embodiment of the present disclosure has an improved ability to remove all the gases. Meanwhile, it could be seen that the photocatalytic filter prepared according to the second embodiment of the present disclosure had an increased ability to remove ammonia, acetaldehyde and acetic acid, compared to the photocatalytic filter prepared according to the first embodiment of the present disclosure.

TABLE 4A
Removal rate of each gas as a function of time (Ammonia (NH₃))

| | Removal rate (%) | | |
|---|---|---|---|
| | Ammonia (NH₃) | | |
| Time | P25 | Photocatalyst of first | Photocatalyst of second |
| (min) | photocatalyst | embodiment | embodiment |
| 30 | 58.9 | 88.7 | 94.1 |
| 60 | 65.4 | 93.1 | 95.9 |
| 120 | 71.3 | 94.8 | 96.9 |
| 180 | 78.6 | 95.7 | 96.9 |

TABLE 4B
Removal rate of each gas as a function of time
(Acetaldehyde (CH3CHO))

| | Removal rate (%) | | |
|---|---|---|---|
| | Acetaldehyde (CH₃CHO) | | |
| Time | P25 | Photocatalyst of first | Photocatalyst of second |
| (min) | photocatalyst | embodiment | embodiment |
| 30 | 7.9 | 27.8 | 41.3 |
| 60 | 31.1 | 46.8 | 61.1 |
| 120 | 65.2 | 79.0 | 90.7 |
| 180 | 83.6 | 94.7 | 97.2 |

TABLE 4C
Removal rate of each gas as a function of time
(Acetic acid (CH3COOH))

| | Removal rate (%) | | |
|---|---|---|---|
| | Acetic acid (CH₃COOH) | | |
| Time | P25 | Photocatalyst of first | Photocatalyst of second |
| (min) | photocatalyst | embodiment | embodiment |
| 30 | 91.9 | 80.4 | 81.7 |
| 60 | 95.6 | 85.6 | 85.2 |
| 120 | 97.7 | 90.0 | 90.5 |
| 180 | 98.1 | 92.6 | 95.7 |

* molar ratio

TiO₂/H₂WO₄/Fe₂O₃=100/10/3 weight ratio (TiO₂/H₂WO₄/Fe₂O₃=1.0/0.032/0.015 molar ratio) First Embodiment

TiO₂/H₂WO₄/nano Fe₂O₃=100/10/1 weight ratio (TiO₂/H₂WO₄/nano Fe₂O₃=1.0/0.032/0.005 molar ratio) Second Embodiment

As described above, the photocatalytic filter of the present disclosure shows a high removal rate of each gas in the mixed gases including three different gases (acetaldehyde, ammonia and acetic acid). In addition to these gases and combinations of these gases, the photocatalytic filter of the present disclosure is also effective against other gases and combinations thereof if these gases are well absorbed onto the surface of the photocatalytic filter.

As described above, the photocatalytic filter according to the present disclosure shows a high removal rate of each gas in mixed gases. Moreover, it shows high rates of removal of all gases from the initial stage of a competitive reaction. In addition, according to the method for manufacturing the photocatalytic filter according to the present disclosure, the photocatalyst has high adhesion to the support.

While various embodiments have been described above, it will be understood to those skilled in the art that the embodiments described are by way of example only. Accordingly, the disclosure described herein should not be limited based on the described embodiments.

What is claimed is:

1. A method of manufacturing a photocatalytic filter, the method including:
providing a photocatalytic dispersion by dispersing titanium dioxide (TiO₂) nanopowders and metal compounds in water, wherein the metal compounds include nanopowders including an iron (Fe) compound;
coating a support with the photocatalytic dispersion;
drying the coated support; and
sintering the dried support.

2. The method of claim 1, wherein the metal compounds include a tungsten (W) compound including atom H.

3. The method of claim 2, wherein the tungsten (W) compound includes H₂WO₄.

4. The method of claim 1, wherein the metal compounds include a tungsten (W) compound including H₂WO₄, WO₃, WCl₆, or CaWO₄.

5. The method of claim 1, wherein the iron (Fe) compound includes a Fe³⁺ compound.

6. The method of claim 1, wherein the iron (Fe) compound includes FeCl₂, FeCl₃, Fe₂O₃, or Fe(NO₃)₃.

7. The method of claim 2, wherein the tungsten (W) compound has a molar ratio between 0.0032 and 0.0064 moles per mole of titanium dioxide.

8. The method of claim 4, wherein the tungsten (W) compound has a molar ratio between 0.0032 and 0.0064 moles per mole of titanium dioxide.

9. The method of claim 1, wherein the iron (Fe) compound has a molar ratio between 0.00125 and 0.0125 moles per mole of titanium dioxide.

10. The method of claim 1, wherein the support includes porous ceramic.

11. The method of claim 1, wherein the coating of the support includes dip-coating the support.

12. The method of claim 1, wherein the sintering of the dried support is performed at a temperature between 350° C. and 500° C. for 0.5 to 3 hours.

13. A photocatalytic filter, including:
a support; and
a photocatalytic material and metal compounds coated on the support, wherein the metal compounds include nanopowders including an iron (Fe) compound.

14. The filter of claim 13, wherein the metal compounds include a tungsten (W) compound including atom H.

15. The filter of claim 14, wherein the tungsten (W) compound includes H₂WO₄.

16. The filter of claim 13, wherein the metal compounds include a tungsten (W) compound including H₂WO₄, WO₃, WCl₆, or CaWO₄.

17. The filter of claim 13, wherein the photocatalytic material includes titanium dioxide (TiO₂), and the metal compounds include a tungsten (W) compound having a molar ratio between 0.0032 and 0.0064 moles per mole of titanium dioxide.

18. The filter of claim 13, wherein the iron (Fe) compound includes Fe³⁺ compound.

19. The filter of claim 13, wherein the photocatalytic material includes titanium dioxide (TiO₂), and the iron (Fe) compound has a molar ratio between 0.00125 and 0.0125 moles per mole of titanium dioxide.

20. The filter of claim 13, wherein the support includes porous ceramic.
